(19) United States
(12) Patent Application Publication
(10) Pub. No.: US 2016/0325965 A1
(43) Pub. Date: Nov. 10, 2016

(54) ELEVATOR PROVIDED WITH A SAFETY DEVICE ARRANGEMENT

(71) Applicants: Markku HAAPANIEMI, Helsinki (FI); Matti RASANEN, Hyvinkaa (FI); Markku HAIVALA, Hyvinkaa (FI); Janne MIKKONEN, Jarvenpaa (FI); Esko AULANKO, Kerava (FI); Ari KATTAINEN, Hyvinkaa (FI)

(72) Inventors: Markku HAAPANIEMI, Helsinki (FI); Matti RASANEN, Hyvinkaa (FI); Markku HAIVALA, Hyvinkaa (FI); Janne MIKKONEN, Jarvenpaa (FI); Esko AULANKO, Kerava (FI); Ari KATTAINEN, Hyvinkaa (FI)

(73) Assignee: Kone Corporation, Helsinki (FI)

(21) Appl. No.: 15/211,325

(22) Filed: Jul. 15, 2016

Related U.S. Application Data
(63) Continuation of application No. PCT/FI2014/050974, filed on Dec. 10, 2014.

(30) Foreign Application Priority Data
Jan. 21, 2014 (FI) 20145057

(51) Int. Cl. B66B 5/00; B66B 5/22

(52) U.S. Cl. CPC B66B 5/005; B66B 5/22; B66B 5/044

(57) ABSTRACT

The object of the invention is an elevator provided with a safety device arrangement, which elevator comprises at least an elevator car traveling along guide rails and a safety brake device for stopping unintended movement of the elevator car. The safety device arrangement comprises a tuning apparatus disposed on the elevator car for detecting a presence on the roof of the elevator car.

This application is a continuation of PCT International Application No. PCT/FI2014/050974 which has an International filing date of Dec. 10, 2014, and which claims priority to Finnish patent application number 20145057 filed Jan. 21, 2014, the entire contents of both of which are incorporated herein by reference.

The object of the invention is an elevator, as defined in the preamble of claim 1, said elevator being provided with a safety device arrangement, more particularly for working on the roof of the elevator car.

Situations are encountered during the operation of an elevator when someone must go onto the roof of the elevator car, either for inspections, servicing or e.g. for some other repair. If the height of the top clearance of the elevator hoistway is shallow, sufficient safety spaces, which prevent personal injuries occurring, for personnel working on the roof of the elevator car cannot be guaranteed without special procedures.

In this case movement of the elevator car and of the counterweight must be prevented in some other way than by means of the operating brakes of the elevator. It is known that this can be done by locking the elevator car and/or the counterweight into their positions on the guide rail e.g. by means of a safety gear, a latch or wedges. This is, however, awkward, laborious and time-consuming, and necessitates working in the elevator hoistway. Another known solution is to fix a rope clamp to the hoisting roping, by means of which rope clamp the hoisting roping is bound fast to e.g. the overhead beam of the hoistway. This is also, however, an awkward and time-consuming solution and requires special tools.

Many other different solutions have also been made according to prior art for achieving adequate safety spaces in the top part of an elevator hoistway. For example, known in the art are safety solutions in which one or more turnable buffers are disposed below the counterweight, which buffer(s) is/are lifted upright before going onto the roof of the elevator car to work. The length of the buffers is such that the movement of the counterweight, and at the same time the movement of the elevator car, stops before the elevator car rises too high with respect to the roof of the elevator hoistway. One problem, among others, in these solutions is, however, that the hoistway space might have been dimensioned so precisely that there is no proper space in the bottom part of the elevator hoistway for turnable buffers. Another problem is that the aforementioned buffers ensuring the top safety space are in the bottom part of the elevator hoistway, i.e. right at the other end of the elevator hoistway. In this case installing the buffers into the safe position takes extra time and it might also happen that for this reason they are not visited beforehand to install them into the safe position, in which case the safety of people working on the roof of the elevator car is not ensured.

If, on the other hand, the turnable safety buffers are in the top part of the elevator hoistway, that also can cause situations in which a person could not or did not remember to go and turn the buffers into the safe position before working on the roof of the elevator car is started. This situation also exposes people working on the roof of the elevator car to danger.

In addition to the aforementioned, the safety solutions are often based on electrical supervisions installed in the doors of the hoistway, which supervisions must be switched to the safe position before going onto the roof of the elevator car. Turning the buffers into the safe position and activation of the electrical supervision circuits are often such a complex combination that, particularly e.g. with small tasks, they might be left undone owing to their complexity and for saving the time used. In addition, electrical supervision systems are susceptible to failure.

The purpose of this invention is to eliminate the aforementioned drawbacks and to achieve an elevator provided with a safety device arrangement, wherein the safety device arrangement is easy-to-use and time-saving as well as operationally reliable, and wherein the locking preventing movement of the elevator car is implemented automatically without separate complex and time-consuming procedures. The elevator, according to the invention, provided with a safety device arrangement is characterized by what is disclosed in the characterization part of claim 1. Other embodiments of the invention are characterized by what is disclosed in the other claims.

Advantageous and dependable ways for bringing about a safe space above the elevator car are achieved with the invention. Preferably the safe space to be formed by means of the invention is applicable to and sufficient for performing servicing tasks and other procedures to be carried out from the roof of the elevator car.

Preferably the invention is expressed as an elevator provided with a safety device arrangement, which elevator comprises at least an elevator car traveling along guide rails and a safety brake device for stopping unintended movement of the elevator car, which safety device arrangement comprises a tuning apparatus disposed on the elevator car for detecting a presence on the roof of the elevator car.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can in at least some situations be deemed to be inventive in their own right.

The invention can be implemented e.g. as an elevator in which is a safety device arrangement bringing about the operation of a safety brake device of the elevator car for stopping unintended movement of the elevator car in such a way that a tuning apparatus disposed on the elevator car detects a presence on the roof of the elevator car and, if necessary, causes operation of a safety device.

In one embodiment of the invention the tuning apparatus comprises at least a tread base that is on the roof of an elevator car and that gives under a weight, the giving movement under which weight causes operation of a safety device. For example, the tuning apparatus can comprise at least tread base arranged movably, preferably movably in the vertical direction, on top of the roof of the elevator car, a detector of movement of the tread base and a transmission means for activating a safety brake device into a standby state or into a braking state as a consequence of movement of the tread base. Preferably the tread base is adapted to move on vertical guide rails above the roof of the elevator car and to rest supported on spring means, as well as to cover essentially the whole of the roof of the elevator car.

The invention enables a safe way of fabricating an elevator that has a shallow top clearance; at it most advantageous the top clearance can even be minimized to the minimum, or close to the minimum, required by the trajectories of the elevator. Thus when the elevator car is in its uppermost possible position on its trajectory, the hoistway space above the elevator car is small and the height of the elevator hoistway can easily be fitted inside the building. Preferably the safety device to be used in the invention is adapted to an elevator solution that in itself shortens the top hoistway space needed on the trajectory of the elevator car. Most preferably solutions can be achieved in this way wherein the roof of the elevator hoistway is at most 2400 mm higher than the floor of the topmost floor level of the elevator, in which case when fabricating the roof of the building the room height of the topmost floor level determines the structures needed and the height of the elevator hoistway does not affect the method of building the roof. The suspension of the elevator car from its bottom part, e.g. using a 2:1 underslung suspension, easily eliminates the need for suspension parts above the elevator car. In this type of suspension from the bottom part of the elevator car, the passage of the hoisting ropes is arranged to the sides of the elevator car and the supporting of the hoisting ropes, in relation to the elevator hoistway, in the top part of the elevator hoistway is arranged, e.g. by means of diverting pulleys, below the roof of the elevator hoistway. Likewise the top wheel of the rope loop of the overspeed governor is supported in its position below the roof of the elevator hoistway. The suspending hoisting ropes can be steel ropes or ropes, e.g. flat belts. One advantage of the solution according to the invention is that by means of it movement of the elevator car can be effectively, dependably and safely prevented. Another advantage is that the solution is very easy and quick to use, and does not necessitate awkward working in the hoistway nor preliminary procedures in the top end or bottom end of the elevator hoistway. Another advantage is the improvement in safety compared to conventional solutions, because the locking of unintended movement of the elevator car switches on automatically when stepping onto the roof of the elevator car. In this case situations cannot arise where switching the safety circuit on would be forgotten, or where a person could not be bothered to switch it on because of its complexity, e.g. for a short job to be performed on the roof. Another advantage is that the solution according to the invention also enables types of elevator applications that, for some reason, lack natural top clearances. Another advantage is that the apparatus comprised in the arrangement takes little space. A further advantage is also that the solution is inexpensive and simple to implement.

In the following, the invention will be described in detail by the aid of some examples of its embodiment with reference to the attached diagrammatic and simplified drawings, wherein

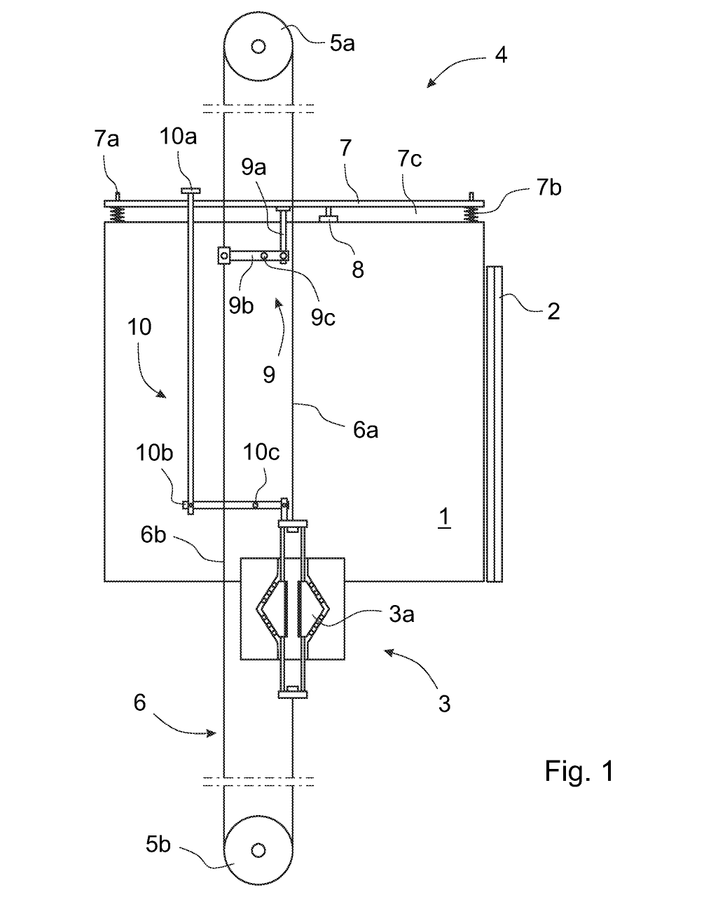

FIG. 1 presents a side view of an elevator car, which is provided with one safety device arrangement according to the invention, for preventing unintended movement of the elevator car,

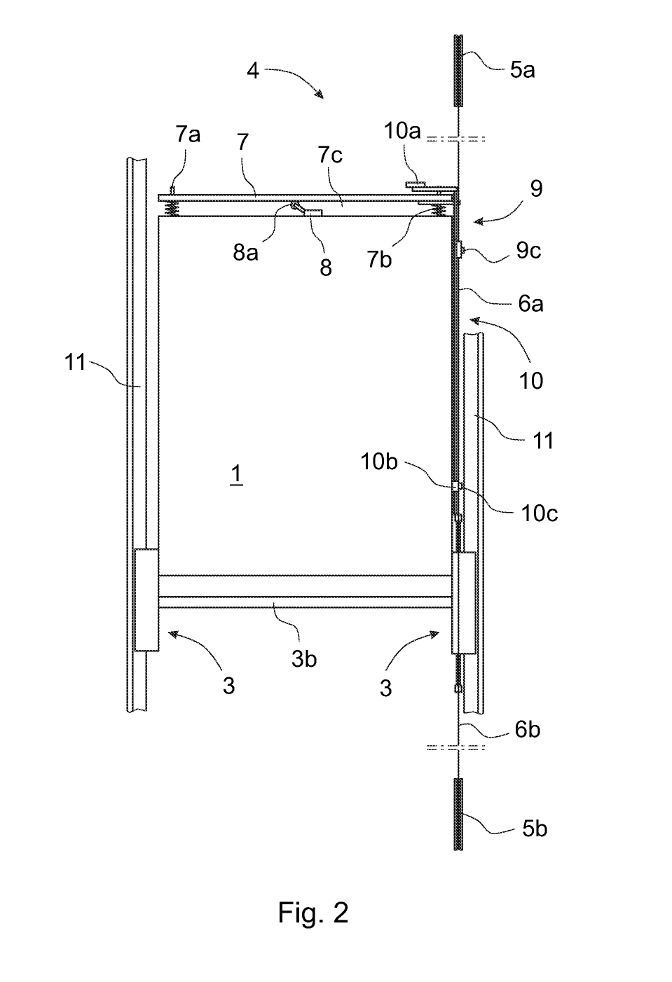

FIG. 2 presents the elevator car according to FIG. 1 as viewed from the direction of the rear wall of the elevator car,

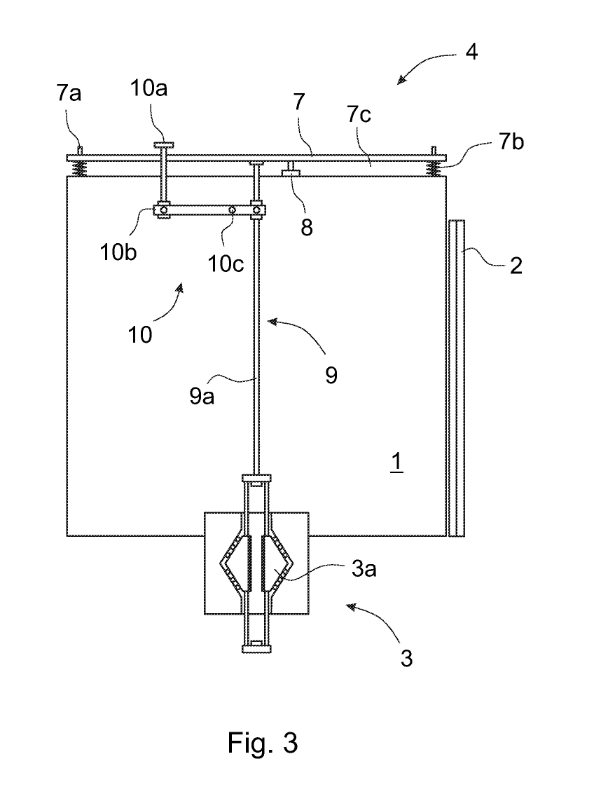

FIG. 3 presents a side view of an elevator car, which is provided with another safety device arrangement according to the invention, for preventing unintended movement of the elevator car,

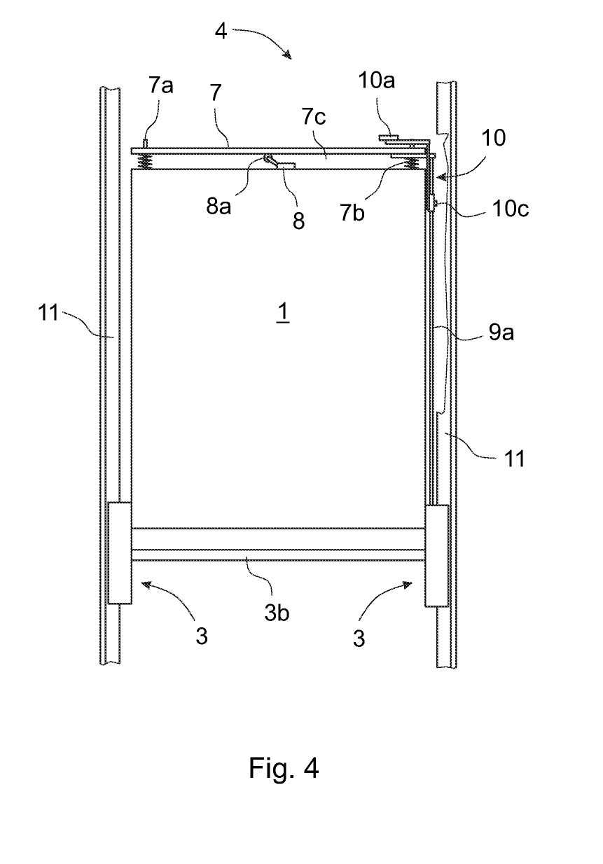

FIG. 4 presents the elevator car according to FIG. 3 as viewed from the direction of the rear wall of the elevator car,

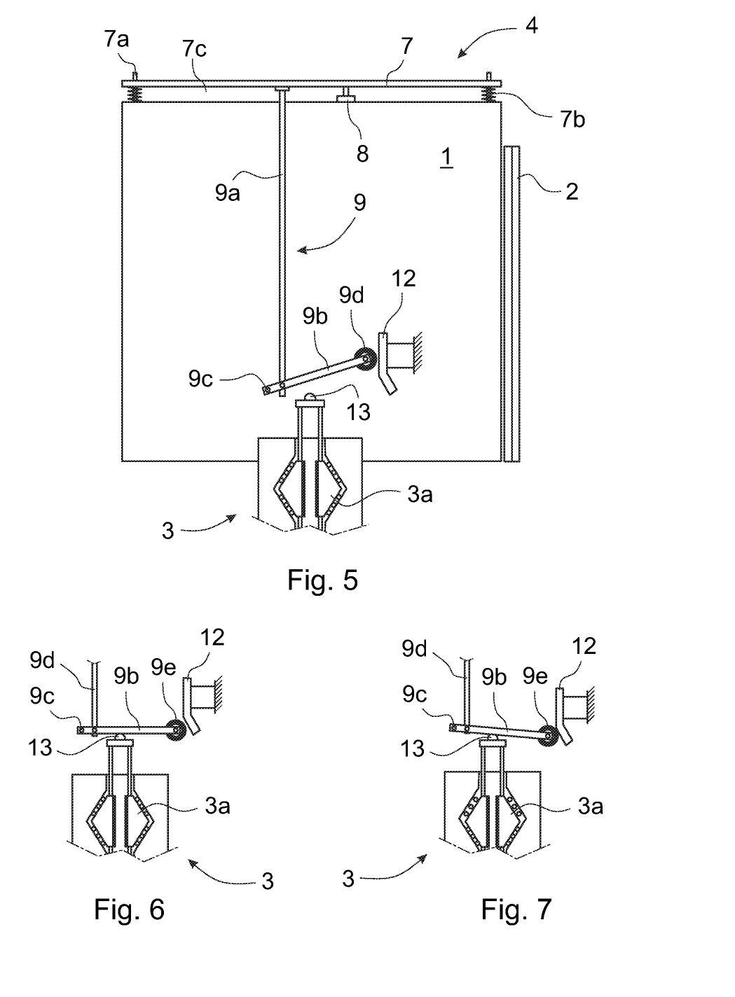

FIG. 5 presents a side view of an elevator car, which is provided with yet another safety device arrangement according to the invention, for preventing unintended movement of the elevator car, in a situation in which no-one is on the roof of the elevator car,

FIG. 6 presents a detail, as viewed from the side of the elevator car, of the bottom end of the lever system of the safety device arrangement according to FIG. 5 in a situation in which a person is on the roof of the elevator car, and

FIG. 7 presents a detail, as viewed from the side of the elevator car, of the bottom end of the lever system of the safety device arrangement according to FIG. 5 in a situation in which an unintended movement upwards has stopped.

FIGS. 1 and 2 present a simplified view of one type of safety device arrangement according to the invention for preventing unintended movement of the elevator car 1 and at the same time for creating the upper safety space needed in the elevator hoistway. The safety device arrangement of FIG. 1 is presented as viewed from the side of the elevator car 1, and in FIG. 2 as viewed from the direction of the rear wall of the elevator car 1. For the sake of clarity, the guide rails of the elevator car 1 are not presented in FIG. 1.

The elevator car 1 can be a conventional elevator car provided with a car door 2, said elevator car having the rope 6 of the overspeed governor connected to the wedges 3a of a bidirectional safety gear functioning as a safety brake device 3 to stop unintended movement of the elevator car 1. On both sides of the elevator car 1 is one safety gear functioning as a safety brake device 3, which are connected to each other via a synchronization lever 3b, in which case the wedges 3a of both safety gears act in the same way and at the same time.

FIGS. 1 and 2 present only a part of the overspeed governor of the elevator car, i.e. the rope pulley 5a of the overspeed governor in the top end of the hoistway and the diverting pulley 5b in the bottom end of the hoistway, as well as the rope 6 of the overspeed governor, the first part of which rope is connected to the wedges 3a of the bidirectional safety gear functioning as the safety brake device 3 of the elevator car and is marked with the reference number 6a, and the second part of which rope is connected to the lever apparatus 9 functioning as a transmission means of the safety device arrangement and is marked with the reference number 6b.

The safety device arrangement of an elevator, said arrangement being according to the invention, comprises a tuning apparatus 4, for displacing the wedges 3a of the safety brake device 3, i.e. for example a safety gear, into such a position that the wedges 3a compress the elevator guide rail 11 that is between the wedges 3a of the safety gear with a force that prevents unintended movement of the elevator car 1, in this case upwards.

The tuning apparatus comprises at least a plate-like or meshed plate type tread base 7 arranged movably in the vertical direction on vertical guide rails 7a, which tread base is disposed immediately above the roof of the elevator car 1 and to rest supported on spring means 7b, as well as to cover essentially the whole of the roof of the elevator car 1 in such a way that when stepping onto the roof a person must always go on top of the tread base 7. Between the top surface of the roof of the elevator car 1 and the bottom surface of the tread base 7 is an air gap 7c for enabling vertical movement of the tread base 7. Additionally, between the top surface of the roof of the elevator car 1 and the bottom surface of the tread base 7 is a supervision contact 8 belonging to the tuning apparatus 4 and functioning as a movement detector of the tread base 7, which supervision contact is arranged to detect vertical movement of the tread base 7 and to disconnect the safety circuit of the elevator when the tread base 7 moves downwards, in which case the elevator cannot be driven. The roller of the supervision contact 8 leans from below on the bottom surface of the tread base 7 and moves the lever of the supervision contact 8 up and down when the tread base 7 moves up and down.

The tuning apparatus 4 also comprises a lever apparatus 9 functioning as a transmission means, in which is e.g. a ram part 9a, a lever part 9b and a hinge 9c in the lever part 9b, by means of which hinge the lever part 9b is hinged to the elevator car 1, and the location of which hinge 9c in relation to the ends of the lever part 9b is arranged to determine the lever ratio and at the same time the movement distance of the ends of the lever part 9b. The lever part 9b of the lever apparatus 9 is connected at its first end to the tread base 7 via the ram part 9a and at its second end to the second part 6b of the rope 6 of the overspeed governor. The lever part 9b of the lever apparatus 9 is hinged by means of the hinge 9c to the elevator car 1 in such a way that when the tread base 7 is pressed downwards after a person has stepped onto the tread base 7, the lever apparatus 9 pulls, by means of the second end of the lever part 9b, the second part 6b of the rope 6 of the overspeed governor upwards by a distance determined by the lever ratio, in which case at the same time the first part 6a of the rope 6 of the overspeed governor moves the same amount downwards and displaces the wedges 3a of the safety gear to compress the guide rail 11. In this case the elevator car 1 is locked into its position by means of the bidirectional safety gear functioning as the safety brake device 3 and in this way a sufficiently large top safety space is formed enabling working in the hoistway.

The elevator safety device arrangement according to the invention also comprises a bypass apparatus 10 for the locking of the elevator car 1, by using which the locking of the elevator car 1 implemented with the wedges 3a of the safety gear can be temporarily removed, e.g. for performing a service drive. The locking-bypass apparatus 10 comprises at least a lever arrangement, comprising e.g. a ram part 10a, a lever part 10b and a hinge 10c in the lever part 10b, by means of which hinge the lever part 10b is hinged to the elevator car 1, and the location of which hinge 10c in relation to the ends of the lever part 10b is arranged to determine the lever ratio and at the same time the movement distance of the ends of the lever part 10b. At the top end of the ram part 10a is e.g. a pedal extending to above the top surface of the tread base 7, said pedal to be pressed by foot or by hand. The lever part 10b of the bypass apparatus 10 is connected at its first end to the bottom end of the ram part 10a and at its second end e.g. to the wedges 3a of the safety gear functioning as a safety brake device 3 in such a way that when pressing the pedal of the ram part 10a and keeping the ram part 10a activated, i.e. pressed downwards, the locking-bypass apparatus 10 detaches and keeps the safety gear wedges 3a off the elevator guide rails 11, in which case the elevator car 1 can be driven e.g. on service drive.

FIGS. 3 and 4 present a simplified view of a safety device arrangement, according to a second embodiment of the invention, for preventing unintended movement of the elevator car 1 and at the same time for creating the upper safety space needed in the elevator hoistway. The safety device arrangement in FIG. 3 is presented as viewed from the side of the elevator car 1, and in FIG. 4 as viewed from the direction of the rear wall of the elevator car 1. The safety device arrangement according to FIGS. 3 and 4 differs from the safety device arrangement according to FIGS. 1 and 2 only in that the lever apparatus 9 and the locking-bypass apparatus 10 are different to those in the safety device arrangement according to FIGS. 1 and 2. In the solution according to FIGS. 3 and 4 the lever apparatus 9 is arranged to act directly on the movement of the wedges 3a of the safety gear without the transmission of the rope 6 of the overspeed governor. The lever apparatus 9 can in this case be composed of just a ram part 9a, as is presented in FIGS. 3 and 4, or the lever apparatus 9 can have a lever transmission changing transmission ratio and travel distances. In this case the transmission is direct, in which case the ram part 9a is e.g. a rod, which is connected directly to the wedges 3a of the safety gear functioning as a safety brake device 3 in such a way that when the tread base 7 moves a certain distance downwards or upwards the wedges 3a move the same distance downwards or upwards. The ram part 9a is in this case connected at its first end to the tread base 7 to move along with the vertical movement of the tread base 7, and at its second end to the wedges 3a of the safety gear.

Correspondingly, the lever arrangement of the locking-bypass apparatus 10 is now, owing to the embodiment, arranged to act on the ram part 9a of the lever apparatus 9 for locking and not directly on the wedges 3a of the safety gear, although that solution also would be fully possible. When the ram part 10a of the locking-bypass apparatus 10 is pressed and held pressed down, the lever part 10b turns around its hinge 10c that is hinged to the elevator car 1 and the second end of the lever part 10b connected to the ram part 9a of the lever apparatus 9 for locking rises upwards at the same time pulling the wedges 3a away from the elevator guide rails, in which case the elevator car 1 can be driven e.g. on service drive.

Additionally, in the top part of the hoistway is a safety shoulder fixed to a wall or to a guide rail, which shoulder eliminates the effect of the bypass apparatus 10 or prevents the use of the bypass apparatus 10 when the elevator car 1 is so high that the top safety space would be too shallow. In this case the elevator car 1 locks into its position and will no longer rise higher.

The tuning apparatus 4 is arranged to return automatically to normal drive mode after people have left the roof of the elevator car 1 and got off the tread base 7. In this case separate electrical supervision circuits differing from normal are not needed.

FIGS. 5-7 present a simplified view of a safety device arrangement, according to a third embodiment of the invention, for preventing unintended movement of the elevator car 1 and at the same time for creating the upper safety space needed in the elevator hoistway. FIG. 5 presents a situation in which no-one is on the roof of the elevator car, in which case the tread base 7 is in its upper position and the safety gear wedges 3a are detached from the elevator guide rails 11, so the elevator car 1 can move freely.

Correspondingly, FIG. 6 presents a situation in which on the roof of the elevator car 1 is a person who has stepped onto the tread base 7 and the tread base 7 has been pressed downwards and has also tripped the safety arrangement in such a way that the safety gear wedges 3a are detached from the elevator guide rails 11, so the elevator car 1 can be driven upwards up until a safe height.

FIG. 7 presents a situation in which on the roof of the elevator car 1 is a person who has stepped onto the tread base 7 and the elevator car 1 has been driven so far upwards that it has stopped at the bottom limit of the top safety space.

The solution according to FIGS. 5-7 differs from the solutions according to FIGS. 1-4 e.g. in that the lever apparatus 9 for locking, said apparatus functioning as a transmission means, is arranged to pull the wedges 3a of the safety gear against the guide rails 11 only when the elevator car 1 has risen to be so high that the lever part 9b of the lever apparatus 9 has hit the rigid detent 12 that is in the elevator hoistway. The detent 12 is disposed in a fixed manner in the elevator hoistway at such a height that a sufficiently high top safety space forms in the top end of the elevator hoistway, into which top safety space the elevator car 1 is not able to ascend when people are on the roof of the elevator car, even though the elevator car 1 in normal drive would be able to ascend higher when driving to the landing of the topmost floor.

The tuning apparatus 4 in this solution comprises a lever apparatus 9, in which is e.g. a ram part 9a, a lever part 9b and a hinge 9c at the first end of the lever part 9b, by means of which hinge the lever part 9b is hinged to the elevator car 1. At the second end of the lever part 9b is a roller 9d, which is arranged to hit the detent 12 that is disposed in a fixed manner in the hoistway for stopping unintended upward movement of the elevator car and at the same time for creating the upper safety space needed in the elevator hoistway.

The ram part 9a is connected at its top end to the tread base 7 to move downwards and upwards along with the tread base 7, and at its bottom end to the lever part 9b, to the location between the first end and second end of the lever part 9b to give the desired lever ratio. The lever apparatus 9 is dimensioned in such a way that in normal operation of the elevator the lever part 9b is turned away from the front of the detent, e.g. into its upper position as presented in FIG. 5, in which case the lever arm 9b also does not press the wedges 3a of the safety gear downwards because the lever arm does not hit the ram detent 13 of the wedges 3a of the safety gear. In this case the elevator can be driven normally.

FIG. 6 presents a situation in which a person goes onto the roof of the elevator car 1 and steps onto the tread base 7, in which case the tread base 7 is pressed downwards against the spring means 7b and at the same time the ram part 9a presses downwards, pressing also the lever part 9b to turn downwards around the hinge 9c, until the bottom surface of the lever part 9b is against, or almost against, the ram detent 13 of the wedges 3a of the safety gear, and the roller 9d on the second end of the lever part 9b has turned into its outermost position so far that the roller 9d would hit the detent 12 if the elevator car 1 were at the height of the detent 12. When the tread base 7 has been pressed downwards, the supervision contact 8 has disconnected the safety circuit of an elevator, but in this state the elevator can still be driven on service drive as long as the elevator car 1 is below the detent 12. In this case a separate bypass apparatus 10 according to FIGS. 1-4 is not needed in the safety arrangement.

FIG. 7 presents a situation in which at least one person is on the roof of the elevator car 1 and the elevator car 1 has been driven to the bottom limit of the top safety space. In this case the roller 9d of the lever part 9b of the lever apparatus 9 has lowered to its bottom position and has hit the detent 12, which has pressed the second end of the lever part 9b downwards so much that the bottom surface of the lever part 9b has at the same time pressed the wedges 3a of the safety gear downwards and against the guide rails of the elevator car, in which case the movement of the elevator car 1 has stopped and a sufficiently high top safety space has remained in the top end of the elevator hoistway.

When the person has left the roof of the elevator car 1, the lever apparatus 9 is arranged to be returned to normal drive mode either manually or automatically. In the manually returnable solution, the return lever is disposed e.g. on the overhead beam of the car door, in which case it is always easily reachable from a landing.

What is common to the solutions of all the embodiments of the invention is, inter alia, that in the safety device arrangement is a tuning apparatus 4 disposed on the roof of the elevator car 1, by means of which tuning apparatus the presence of people on the roof is detected and a sufficient top safety space is created for working in the elevator hoistway. The top safety space is created by acting e.g. on the wedges 3a of the safety gear functioning as a safety brake device 3 of the elevator in such a way that the safety gear is brought into standby mode or is activated by displacing the wedges 3a of the safety gear to compress the guide rails 11 of the elevator car 1 when at least one person goes onto the roof of the elevator car 1. Bringing the safety gear into standby mode or activation can be performed mechanically, e.g. with lever apparatuses, such as in the embodiments described above, or also electrically.

It is obvious to the person skilled in the art that different embodiments of the invention are not only limited to the examples described above, but that they may be varied within the scope of the claims presented below. Thus, for example, instead of a mechanical tuning apparatus, the tuning apparatus can be partly optical, e.g. a light curtain, connected to electrical actuators.

It is also obvious to the skilled person that the mechanical lever apparatuses presented are just simple examples and they can be constructed also in other ways.

It is also obvious to the person skilled in the art that the safety brake device of an elevator presented above can be some other brake device gripping to the guide rails of the elevator car than the normal safety gear of the elevator.

It is likewise obvious to the skilled person that the solution according to the invention can just as well be applied also to stopping the unintended downward-directed movement of an elevator car.

1. Elevator provided with a safety device arrangement, which elevator comprises at least an elevator car traveling along guide rails and a safety brake device for stopping unintended movement of the elevator car, wherein the safety device arrangement comprises a tuning apparatus disposed on the elevator car for detecting a presence on the roof of the elevator car.

2. Elevator according to claim 1, wherein the tuning apparatus comprises at least tread base arranged movably, preferably movably in the vertical direction, on top of the roof of the elevator car, a detector of movement of the tread base and a transmission means for activating a safety brake device into a standby state or into a braking state as a consequence of movement of the tread base.

3. Elevator according to claim 1, wherein the tread base is adapted to move on vertical guide rails immediately above the roof of the elevator car and to rest supported on spring means, as well as to cover essentially the whole of the roof of the elevator car.

4. Elevator according to claim 1, wherein between the top surface of the roof of the elevator car and the bottom surface of the tread base is an air gap, in which is a supervision contact functioning as a detector of movement of the tread base, which supervision contact is arranged to detect vertical movement of the tread base and to disconnect the safety circuit of the elevator after the tread base has moved downwards.

5. Elevator according to claim 1, wherein the transmission means is a mechanical lever apparatus, which is connected at its first end to the tread base and at its second end to the rope of the overspeed governor in such a way that when the tread base moves downwards the rope of the overspeed governor displaces the wedges of a safety device brake provided with wedges against the guide rails of the elevator car for locking the elevator car into its position.

6. Elevator according to claim 1, wherein the transmission means is a mechanical lever apparatus, which is connected at its first end to the tread base and at its second end directly to the wedges of a safety device brake provided with wedges in such a way that when the tread base moves downwards the transmission means displaces the wedges against the guide rails of the elevator car for locking the elevator car into its position.

7. Elevator according to claim 1, wherein the transmission means is a mechanical lever apparatus, in which is a ram part, which is connected at its first end to the tread base, and on the second end of which ram part is a lever part, which is hinged at its first end to the elevator car, and at the second end of which lever part is a roller, which is arranged in its outermost position to hit a rigid detent that is in the top part of the elevator hoistway, and after it has hit the detent to displace the wedges against the guide rails of the elevator car for locking the elevator car into its position.

8. Elevator according to claim 7, wherein when the tread base is in its upper position the lever part has turned, pulled by the ram part, into a position in which the roller at the second end of the lever part is in its innermost position, in which case the roller is arranged to pass by the detent when the elevator car is driving past the detent.

9. Elevator according to claim 1, wherein the safety arrangement comprises a bypass apparatus provided with a ram part, which bypass apparatus is connected either to the rope of the overspeed governor, to a transmission means or directly to the wedges of the safety brake device for the temporary removal of the locking of the elevator car, e.g. for a service run.

10. Elevator according to claim 1, wherein the transmission means is a mechanical lever apparatus, which is connected to the tread base to transmit a movement effect to the rope of an overspeed governor in such a way that when the tread base moves downwards the rope of the overspeed governor displaces the wedges of a safety device brake provided with wedges against the guide rails of the elevator car for locking the elevator car into its position.

11. Elevator according to claim 1, wherein the transmission means is a mechanical lever apparatus, which is connected to the tread base to transmit a movement effect to the wedges of a safety device brake in such a way that when the tread base moves downwards the transmission means displaces the wedges against the guide rails of the elevator car for locking the elevator car into its position.

12. Elevator according to claim 1, wherein the safety brake device is a bidirectional safety gear of an elevator, said safety gear having wedges.

13. Elevator according to claim 1, wherein the elevator car is supported with hoisting ropes from the bottom part of the elevator car.

14. Elevator according to claim 1, wherein the elevator car is supported from the bottom part of the elevator car with hoisting ropes, conducted via diverting pulleys.
